(19) United States
(12) Patent Application Publication
(10) Pub. No.: US 2011/0047529 A1
(43) Pub. Date: Feb. 24, 2011

(54) METHOD FOR AUTOMATIC SCRIPT GENERATION FOR TESTING THE VALIDITY OF OPERATIONAL SOFTWARE OF A SYSTEM ONBOARD AN AIRCRAFT AND DEVICE FOR IMPLEMENTING THE SAME

(75) Inventor: Famantanantsoa Randimbivololona, Toulouse (FR)

Correspondence Address: Perman & Green, LLP, 99 Hawley Lane, Stratford, CT, 06614, US

(73) Assignee: AIRBUS OPERATIONS (SOCIETE PAR ACTIONS SIMPLIFIEE), Toulouse (FR)

(21) Appl. No.: 12/678,143

(22) PCT Filed: Sep. 12, 2008
(86) PCT No.: PCT/FR08/51644

§ 371 Date: Sep. 7, 2010

(30) Foreign Application Priority Data
Sep. 14, 2007 (FR) 07 57615

(51) Int. Cl. G06F 9/44

(52) U.S. Cl. 717/124

(57) ABSTRACT

Method for automatic script generation for testing the validity of operational software of a system onboard an aircraft and device for implementing the same. The aspects of the disclosed embodiments relate to a script generation method for testing the validity of operational software of a system onboard an aircraft, wherein it includes the following steps: a) identifications by a developer of valid test cases in an interactive manner by positioning an entry point and a stop point respectively at the start and at the end of a function of the operational software being tested. b) observing and recording states of variables of said function via the position of the stop point and the entry point. c) automatically generating a test script firstly by analyzing the states of variables observed during the identification of the test cases and secondly by generating a test script in the form of a source code. d) automatically executing in a test execution environment, tests for the generated test script.

This application is National Stage of International Application No. PCT/FR2008/051644 International Filing Date, 12 Sep. 2008, which designated the United States of America, and which International Application was published under PCT Article 21 (s) as WO Publication 2009/047430 A2 and which claims priority from, and the benefit of, French Application No. 200757615 filed on 14 Sep. 2007, the disclosures of which are incorporated herein by reference in their entireties.

### BACKGROUND

The aspects of the disclosed embodiments relate to the field of system operational safety when the operation of these systems relies on the execution of series of logic instructions in a computer.

In particular, the disclosed embodiments relate to a method for generating a programme for testing operational software of a system which must execute series of logic instructions, in particular a system with heightened safety requirements such as an electronic system aimed at being installed onboard an aircraft.

### SUMMARY

The method enables a developer to be able to automatically generate programmes for testing series of logic instructions for operational software of systems aimed at being installed onboard an aircraft. The disclosed embodiments are particularly advantageous in, but not exclusive to the field of aeronautics and, more particularly the field of performing tests on operational software of onboard systems.

For safety reasons, the systems aimed at being installed onboard an aircraft are subjected to checks regarding their correct operation, during which said systems must be proven to meet the certification requirements before an aircraft fitted with such systems is authorised to fly or even enter into commercial use.

Currently, before their installation, these systems are subjected to numerous tests in order to check that they meet the integrity and safety requirements, among others, issued by the certification authorities. These onboard systems can in particular be specialised computers aimed at performing possibly significant operations for the aircraft, for example piloting operations. These systems will be hereinafter referred to as computers.

More often than not in current system architectures, each computer is dedicated to an application or several applications of the same nature, for example flight control applications. Each computer includes a hardware part and a software part. The hardware part includes at least one central processing unit (CPU) and at least one input/output unit, via which the computer is connected to a network of computers, external peripherals, etc.

One essential characteristic of the onboard systems, often implemented in the field of aeronautics, is connected to an architecture, as much hardware as software, that avoids as much as possible, any means from being introduced which is unnecessary for the functions dedicated to said systems to be performed.

Thus, contrary to the systems generally found in widespread applications in aeronautics, the computer is not equipped with a complex operating system. In addition, the software is executed in a language as close as possible to the language understood by the central processing unit and the only inputs/outputs available are those required for system operation, for example information originating from sensors or other aircraft elements or information transmitted to actuators or other elements.

The advantage of this type of architecture comes from the fact that the operation of such a system is better controlled. It is not dependant on a complex operating system, of which certain operating aspects are contingent on uncontrolled parameters and which should otherwise be subjected to the same safety demonstrations as application software. The system is simpler and less vulnerable as it only includes the means strictly necessary for the functions of said system to be performed.

On the other hand, the operating conditions of such a system are much more difficult to detect. For example, the system does not include any conventional man/machine interfaces such as keyboards and screens, enabling the correct operation of the series of instructions to be checked, and enabling an operator to interact with this operation, which makes it difficult to perform the essential checks required during the development, verification and qualification of the software.

The software part of the computer includes a software programme specific to the relevant application and which ensures the operation of the computer, whose logic instructions correspond to the algorithms that determine system operation.

In order to obtain system certification, a computer validation phase is performed prior to its use and the use of the aircraft.

In a known manner, the validation phases consists, in general, in checking, at each step of the computer execution process, that it is compliant with the specifications set so that said computer fulfils the expected operation of the system.

This verification of compliance with the specifications is performed, in particular for software programmes, by successive steps from checking the most simple software components to the full software programme integrating all of the components to be used in the target computer.

In a first verification step, the most simple software elements capable of being tested are subjected to tests, known as unit tests. During these tests, the logic instructions, i.e. the code, of said software elements, individually taken, are checked to have been executed in compliance with the design requirements.

In a second step, known as the integration step, different software components having been individually subjected to isolated checks are integrated in order to constitute a unit, in which the software components interact. These different software components are subjected to integration tests aimed at checking that the software components are compatible, in particular at the level of the operational interfaces between said components.

In a third step, all of the software components are integrated into the computer for which they were designed. Validation tests are then performed to prove that the software, formed by the set of components integrated into the computer, is compliant with the specifications, i.e. that it performs the expected functions, and that its operation is reliable and safe.

In order to guarantee that software is safe and in order to meet the certification requirements, all of the tests to which the software has been subjected must also prove, during this validation phase and with an adequate level of certainty, that the software is compliant with the safety requirements for the system in which it is incorporated.

The different tests performed on the software during the validation phase enable it to be assured that no malfunction of said software (which could have an impact on the correct operation of the computers, and therefore on the aircraft and its safety) can occur or that, if a malfunction does occur, the software is capable of managing this situation.

In any case, during the validation phase, and above all for the investigation operations for when anomalies are observed, it is often necessary to ensure that not only the input and output parameters for the computer on which the software is installed are conform to the expected parameters, but also that certain internal software actions are correct.

In this event, due to the specific architecture of the specialised computers for onboard applications, it is generally very difficult to detect the software operating conditions without implementing particular devices and methods.

A first known method consists in installing a file distribution system between the computer being tested with the installed software and an associated platform by using emulators. An emulator refers to a device enabling the logic operation of a computing unit of a computer processor to be simulated on the associated platform.

In such an operating mode with an emulator, the computer processor is replaced by a probe, which creates the interface with the associated platform supporting the processor emulation.

It is thus possible to execute the software to be tested on the computer, except for the processor part, and by the functions performed by the associated platform, to detect the operating conditions or certain internal malfunctions of the software, for example in response to input stimulations to the input/output units, in addition to detecting the outputs of said input/output units.

A second method consists in simulating, on a host platform, the operation of the computer used to execute the programme being tested. In this event, the software being tested must be able to access the files on the host platform, either to read the test vectors or to record the test results.

As the software being tested does not naturally include the functions for such access to the host platform files, the software being tested must be modified in order to integrate these access functions.

In order to transfer information, system call instructions are normally used, which are transmitted by the simulated test environment. The system call instructions can be, for example, the opening of a file, the writing of a file or even the reading of a file. The system call instructions are intercepted by the host platform operating system, which converts them into host platform system calls.

During the computer validation phase, and above all for the investigation operations for when anomalies have been observed, it is often necessary to ensure that not only the input and output parameters for the computer on which the software is installed are conform to the expected parameters, but also that certain internal software actions are correct.

In order to achieve this, a test execution environment for operational software of the computers generates several test programmes, even though the test programmes often represent a significant volume of instruction codes, often more significant in volume than the volume of instruction codes from the software being tested.

Currently, the development of test programmes is performed on a test case by test case basis. A test case refers to the operational path to be implemented in order to reach a test objective. In other words, a test case is defined by a set of tests to be implemented, a test scenario to be performed and the expected results. Thus, each test case for the operational software aimed at being loaded onto the computer is associated with a programme which will simulate the test case. These test programmes are created by developers, who perfectly understand the functions of the software being tested, their context and their running conditions. The development of test programmes passes by two essential steps: a first step which relates to the design of test data and a second step which relates to the writing of instruction chains for test programmes.

The development of test programmes is subjected to a repetitive chain of manual tasks performed by the developer. This repetitive chain of manual tasks is a significant source of error introduction.

In order to resolve this problem, automatic test generators have been developed so as to enable the generation of test case data. With such a method of generating test case data, the developer must express each test objective in a formal language then translate these objectives into a programming language. Each objective thus modelled constitutes a test case.

However, this manner of expressing each test objective can only be applied to simple objectives for simple functions and automation of this manner of expressing each objective is difficult to implement on an industrial scale.

The purpose of disclosed embodiments is to overcome the disadvantages of the techniques previously described. In order to achieve this, the disclosed embodiments relate to a method which enables test programmes to be generated automatically and the validity of the tests performed to be checked.

The implementation of the method according to the disclosed embodiments reduces the costs of the test phase by avoiding the necessity of resorting to manually developing the test programmes. The disclosed embodiments thus enable a level of flexibility regarding the development of test programmes, as the development of the operational software is performed in an incremental manner according to the developments from the tests performed. Indeed, the test programmes are developed in parallel to the operational software tests, which implies that, each time there is a development from at least one test, the test programmes develop at the same time as the operational software tested.

The disclosed embodiments also enable the reliability of test programmes to be improved as the synthesis of these test programmes is performed automatically from scripts unrolled and validated in an interactive manner by the developer.

More precisely, the disclosed embodiments relate to a method for script generation for testing the validity of operational software of a system onboard an aircraft, characterised in that it includes the following steps:

identification by a developer of valid test cases in an interactive manner by positioning an entry point and a stop point respectively at the start and at the end of a function of the operational software being tested.

observing and recording states of variables of said function via the position of the stop point and the entry point.

automatically generating a test script firstly by analysing the states of variables observed during the identification of the test cases and secondly by generating a test script in the form of a source code.

automatically executing in an execution environment, the tests of the generated test script.

The disclosed embodiments can also include one or several of the following characteristics:

between the observation and recording of the states of variables step and the step of automatically generating a test script, a verification step is performed checking the validity of the test cases enabling the developer to decide whether the execution of the function tested is valid with respect to the states of variables observed.

generation of the test script is performed on a test case by test case basis.

between the step of automatically generating the script and the step of automatically executing the script, a source code compilation is created in order to automatically translate said source code of the test script into an equivalent source code in machine language.

the compilation is followed by a test script line editing operation providing a binary code capable of being executed and used in the test execution environment selected by the developer.

test results are generated in a form, directly compatible with the type of test execution environment selected.

The disclosed embodiments also relate to a device simulating the operation of a computer onboard an aircraft, characterised in that it implements the method as previously defined.

The disclosed embodiments can also include the following characteristic: The device is virtually simulated on a testing and debugging host platform.

The disclosed embodiments also relate to a test programme which can be loaded onto a control unit including instruction sequences to implement the method as previously defined, when the programme in loaded onto the unit and is executed.

The disclosed embodiments will be better understood after reading the following description and after examining the accompanying figures. These are presented as a rough guide and in no way as a limited guide to the disclosed embodiments.

### BRIEF DESCRIPTION OF THE DRAWINGS

FIG. 1 illustrates the operational diagram of the method of the disclosed embodiments.

FIG. 2 is a schematic representation of a control unit of the test execution environment, enabling test programmes for operational software to be generated.

This disclosed embodiments relate to a method enabling the automatic generation of scripts for testing operational software throughout the development phase. This method enables each modification made to the operational software during its development to be taken into account.

The notion of operational software is defined as being comprised of a set of programmes. A programme being comprised of a set of written series of instructions, hereinafter referred to as an instruction chain. A script is a set of written instructions performing a particular task.

The method of the disclosed embodiments also enables, via a succession of steps, to control the validity of each test performed on the operational software progressively with its development.

### DETAILED DESCRIPTION

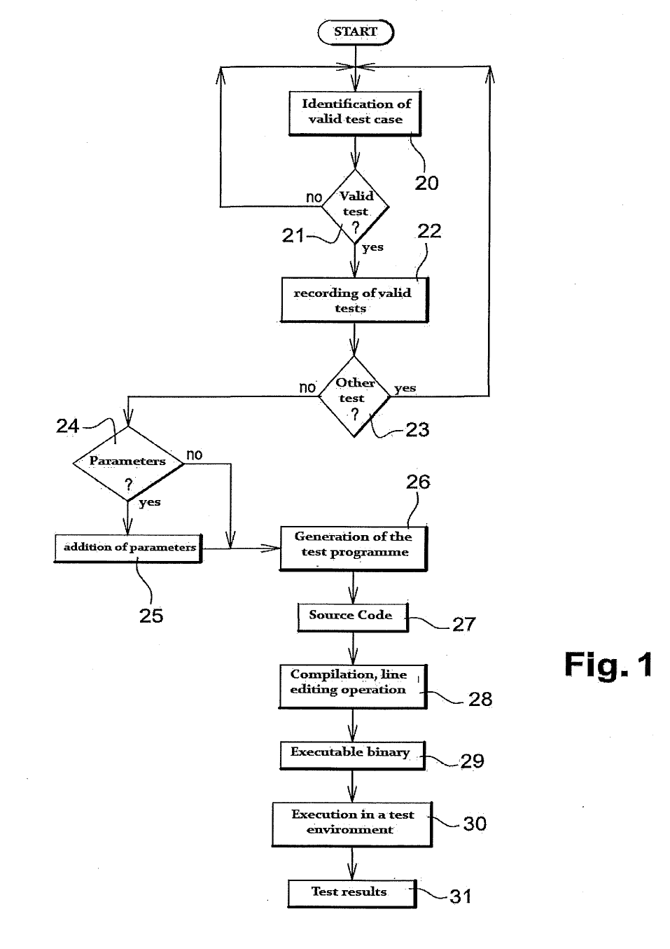

FIG. 1 represents an operational diagram of the method of the disclosed embodiments. This operational diagram corresponds to a mode of embodiment of the disclosed embodiments. This operational diagram includes a step 20 in which the test cases are identified by the developer in an interactive manner. The notion of test case being here a scenario defined by the developer in order to check that the instruction chains of the operational software already debugged correctly meet its specifications, but also that its execution by the computer of the onboard system will not lead to any malfunction of said system. Within the scope of the disclosed embodiments, a developer can define several test cases in order to exert the operational software as much as possible. This developer has the use of a debugger available, which enables him/her in particular to research possible errors in the instruction chains. This debugger also enables the execution of tests to be controlled by positioning an entry point and an exit point or a stop point respectively at the start and at the end of a function of the operational software being tested The test execution control includes in particular a step of observing the state of variables selected by the developer, known as significant variables. These significant variables are variables enabling the developer to check that the values obtained are those expected.

A verification of the validity of the test is performed in step 21, enabling a decision to be made whether the execution of the test is valid with respect to the states of variables observed. In the event where the test is valid, a step 22 offers the developer a validation interface in order to record the valid tests by conserving all of the states of variables observed. In the event where the test is not valid, the method is repeated from step 20.

When step 22 for recording the valid tests is applied, a verification of new test cases is performed in step 23 under the action and decision of the developer. If a new test case is detected, the method is repeated from step 20. If no new test case is detected, a step 26 for generating the test script is applied. This step 26 is preceded by two intermediary steps 24 and 25. The purpose of step 24 is to detect whether the parameters of the test execution environment were set by the developer. These parameters enable the type of test execution environment to be selected, for which the test scripts must be generated. If parameters have been detected, step 25 consists in taking these parameters into account for generating the test script.

Step 26 for generating the test script is performed automatically by a script generator. This script generator firstly analyses the controlled states of variables, which have been recorded after step 20 of identifying the valid test cases and, secondly generates a source code for the test script (step 27).

This operation of generating the source code is performed on a test case by test case basis. The source code is presented directly in a normal programming language, which eases it being understood by the majority of software developers.

In step 28, a source code compilation is created, enabling the source code for the test script to be automatically translated into an equivalent script in machine language. This compilation is followed by a test script line editing operation providing, in step 29, a binary code capable of being executed and used in the test execution environment selected in step 24 or the preconfigured test execution environment.

In step 30, the binary code of the test script is automatically executed in the test execution environment. In step 31, the results from the execution of the tests performed on the operational software are generated in a form directly compatible with the type of test execution environment selected by the developer.

The method presents the advantage of being able to adapt to any type of test execution environment for operational software. It can therefore be adapted to any type of virtual or real environment.

With the method of the disclosed embodiments, the generated test scripts are directly valid and exempt from errors. Indeed, during the test script validation phase, the non-validation of one of said scripts corresponds to the discovery of an error, which implicitly leads to a correction of the tested function of the operational software.

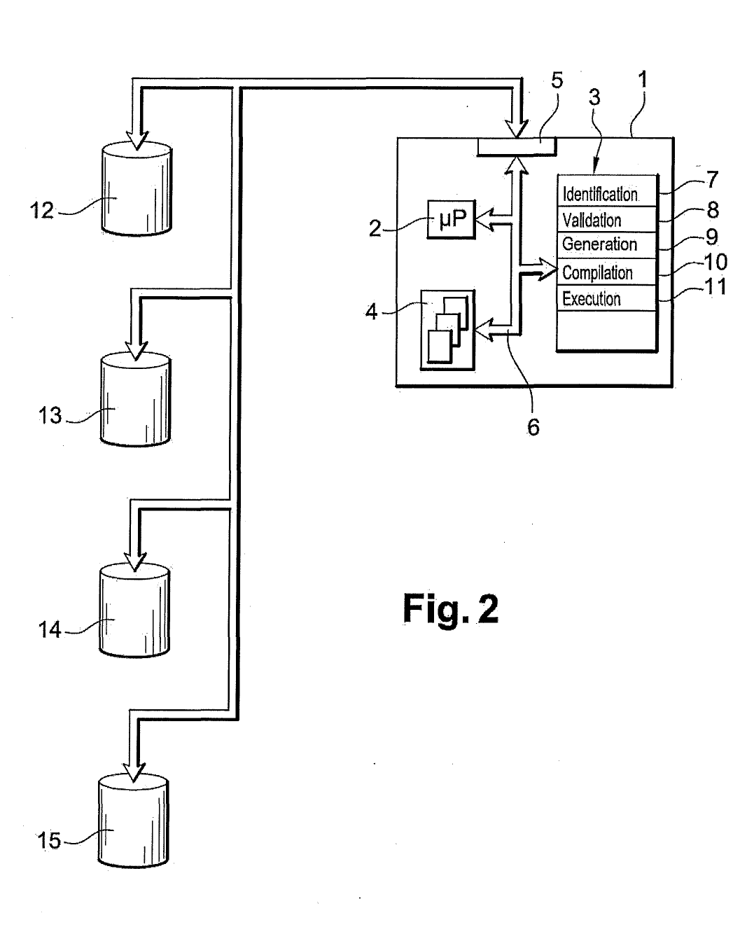

FIG. 2 is a schematic representation of control unit 1 of the test execution environment, enabling the generation of test scripts of the operational software aimed at being loaded onto an onboard system (not represented). FIG. 2 shows an example of control unit 1 of a test execution environment. The test execution environment can be, according to different modes of embodiment, either virtually simulated on a host platform, such as a workstation, or based on an emulator-type piece of hardware equipment. Test execution environment refers to an environment enabling operational software of an onboard system to be checked, corrected, and tested and an operational burn-in to be performed. Control unit 1 of the test environment includes, in a non-exhaustive manner, a processor 2, a programme memory 3, a data memory 4 and an input/output interface 5. Processor 2, programme memory 3, data memory 4 and input/output interface 5 are connected to each other via a bidirectional communication bus 6.

Processor 2 is controlled by the instruction codes recorded in a programme memory 3 of control unit 1.

Programme memory 3 includes, in an area 7, instructions for identifying valid test cases. This identification enables developer interaction via a multi-function interface that can be found in a classic debugger. From among these functions, there is in particular the possibility of positioning an execution control point at the start of the function of the operational software being tested. Another function enables a stop point to be positioned at the end of the function. This developer interaction enables the developer to control the states of variables in order to determine whether the execution of the function was correctly performed.

Programme memory 3 includes, in an area 8, instructions for performing a validation operation. This validation consists in automatically recording all of the controlled states of variables. These states constitute a recording 12 of the valid test cases. This validation also enables all of the controlled states to be edited. These controlled states become the reference value for the validated test cases.

Programme memory 3 includes, in an area 9, instructions for generating test scripts. This generation of test scripts results from an analysis of the states of variables of recording 12. This generation of test scripts is presented in the form of a source code 13. It is presented on a test case by test case basis.

Programme memory 3 includes, in an area 10, instructions for creating a compilation of source code 13 in order to translate this code into machine language. Following this compilation, a line editing operation is performed in order to transform source code 13 (which is found in machine language) into an executable binary code 14.

Programme memory 3 includes, in an area 11, instructions for executing the test script in order to generate test results 15 at the output.

1. A method for script generation for testing the validity of operational software of a system onboard an aircraft, comprising:
identification by a developer of valid test cases in an interactive manner by positioning an entry point and a stop point respectively at the start and at the end of a function of the operational software being tested.
observing and recording states of variables of said function via the position of the stop point and the entry point;
automatically generating a test script firstly by analysing the states of variables observed during the identification of the test cases and secondly by generating a test script in the form of a source code;
automatically executing in a test execution environment, tests for the generated test script.

2. A method according to claim 1, wherein, between the observation and recording of the states of variables step and the step of automatically generating a test script, a verification step is performed checking the validity of the test cases enabling the developer to decide whether the execution of the function tested is valid with respect to the states of variables observed.

3. A method according to any one of claim 1, wherein generation of the test script is performed on a test case by test case basis.

4. A method according to claim 1, wherein, between the step of automatically generating the script and the step of automatically executing the script, a source code compilation is created in order to automatically translate said source code of the test script into an equivalent source code in machine language.

5. A method according to claim 4, wherein the compilation is followed by a test script line editing operation providing a binary code capable of being executed and used in the test execution environment selected by the developer.

6. A method according to claim 1, wherein test results are generated in a form, directly compatible with the type of test execution environment selected.

7. A device simulating the operation of a computer onboard an aircraft, configured to implement the method according to claim 1.

8. A device according to claim 7, characterised in that wherein it is virtually simulated on a testing and debugging host platform.

9. A test programme which can be loaded onto a control unit, including instruction sequences to implement the method according to claim 1, when the programme is loaded onto the unit and is executed.
